(19) United States
(12) Patent Application Publication
(10) Pub. No.: US 2015/0317736 A1
(43) Pub. Date: Nov. 5, 2015

(54) METHODS AND TOOLS FOR GURANTEEING PORTFOLIO EXPECTED RETURN WHILE MINIMIZING RISKS

(71) Applicant: Disi Lian, Dalian (CN)

(72) Inventor: Disi Lian, Dalian (CN)

(21) Appl. No.: 14/373,645

(22) PCT Filed: May 24, 2012
(86) PCT No.: PCT/CN2012/000721

§ 371 Date: Jul. 14, 2015

(30) Foreign Application Priority Data
Apr. 27, 2012 (CN) 201210126669.6

(51) Int. Cl. G06Q 40/06

(52) U.S. Cl. CPC G06Q 40/06

(57) ABSTRACT

Methods and tools for guaranteeing portfolio expected return while minimizing risks are disclosed, Firstly, extracting the user's investment portfolio, the expected return data, the user's position in upper and lower limits of the various investment and the long and short positions in investment requirements and the user's investment orientation, and quantitatively calculating portfolios of financial risks in all positions; Secondly, according to the result of user's data and system risk quantitative calculation and the profit and loss optimization value, dynamically adjusting the actual effective boundary; within the multi-dimensional actual effective boundary calculating the optimum portfolio weights ratio to meet the user's expectation of investment returns and position limits, while minimizing investment risks; Then, listing the corresponding increase or decrease in trading, profit and loss and cash flow when transforming the current portfolio into the optimized portfolio, thus improving the user's investment performance while reducing investment risks.

### BRIEF SUMMARY OF THE INVENTION

This invention primarily concerns the quantitative optimisation of investment portfolios, and specifically refers to a method that quantitatively calculates and financial risks and adjusts the weight ratios of securities in a given portfolio to achieve an optimum weight combination for the aforesaid securities that minimises risk and at the same time satisfies the expected return and any additional given limitations on position size and long or short position boundaries, together with a software tool that is based on the aforesaid method.

### BACKGROUND OF THE INVENTION

There are multiple fields and numerous financial products in today's financial market that investors can choose from, the different types of investment underlyings generate various level of returns which are almost invariably associate with financial risk of different level and types. The critical issue that concerns investors is to quantify the return and risks of investment portfolios at both portfolio level and security level, and adequately adjust the weight combination and long or short trading directions to achieve expected return with minimum associated risk.

Financial software in today's market primarily focus on either providing investors live and historical market data or mechanisms that facilitate electronic-trading and order management; there are investment consultancy software that provide tools that make stock selection recommendation or provide consultation services on the basis of swapping one or more securities in the clients' portfolio for other replacement products. However, software tools that provide market data do not quantitatively calculate every user's investment risks, nor is the correlation between investment return and risks adequately quantified and analysed in the same fashion as the software described in this invention. While most analytical software tools diversify user's portfolio by changing the composition of the clients' portfolio, the fundamental purpose of such software and services is to recommend securities that are not in their clients' present portfolio. The introduction of new security positions in the existing portfolio not only changes the expected return and risk characteristics of the portfolio but also discards the user's view and expected return on some of the existing securities in the portfolio, i.e. the newly introduced securities may cause the user to doubt the risk and credibility of the new portfolio. Therefore simply swapping some securities for some other does not solve the fundamental problem of minimising risk while satisfying one's preference on portfolio composition, position size, long/short position and expected return. Moreover, existing financial analytics software tools do not offer mechanisms that allow users to analyse VaR with hybrid risk factor composition and different time horizon at the same time, neither are mechanisms exist for analysing the impact of active portfolio optimisation on actual portfolio P&L.

### DETAILED DESCRIPTION OF THE INVENTION

As a result of the analysis above, the purpose of this invention is to provide investors a quantitative portfolio optimisation method and a software tool based on that method as such that modify the weight ratio combination of securities in a given portfolio to not only reduce portfolio risk to its mathematical minimum but also satisfy the portfolio's expected return and all user defined position and trade direction limitations, and take optimisation P&L and Stress VaR into account during the optimisation calculation process to achieve a mathematically optimum weight combination. The methods and tools in this invention also aim to provide comparisons on performances prior and after portfolio optimisation, in addition to a detailed list of all trades necessary to achieve the optimised portfolio together with corresponding P&L and cash flows, so that the user can not only better understand the risk associated with a portfolio but also directly evaluate the result of the new optimised portfolio against the existing portfolio in terms of performance and risk by observing efficient frontier and portfolio P&L.

Efficient frontier, as in FIG. 1, specifically means for a given portfolio of securities, the return of any combinations of any securities adheres to the rules of the efficient frontier, which must always fall within the boundary defined by the efficient frontier; for all possible combinations of securities in the given portfolio that produces the same expected return, there must be one optimum combination that achieves such return with mathematically minimum risk.

The unique characteristics of this invention are, as shown in FIG. 1:
i. During the portfolio optimisation process, introducing a hybrid VaR which is adjusted by historical VaR and Monte Carlo VaR, so that not only the margin of error on the definition of the efficient frontier boundary is minimised, but it also is adaptive to any future scenario;
ii. Take the P&L generated during the optimiation process as a calculation factor and dynamically adjust the optimisation boundary accordingly so that the resulting portfolio is the actual absolute optimum that can be achieved mathematically;
iii. During the optimisation process, calculate and quest for the weight combination that produces the minimum risk while satisfying the portfolio expected return as opposed to quest for the mathematical maximum expected return under the same conditions. Minimising investment risk while maintaining an adequate return is what every investor tries to achieve during a financial crisis such as the subprime mortgage crisis initiated credit crunch beginning 2007;
iv. An additional unique benefit of this invention is that not only does this method produce the optimum security weight combination, but it also produces the complete list of trades necessary to achieve the optimum portfolio from the pre-optimisation portfolio, together with trade generated P&L and cash flow.

The logical model of the software tool in this invention which minimises risk while achieving the expected return of a given portfolio and satisfying all position size and long/short trade direction limitations is shown in FIG. 2, the relationships between each modules of the software are detailed in FIG. 3, these modules include:

1) User Data Collection Module, for collecting user specified expected return, position limit, VaR time horizon, long/short position limitation for each security in a given portfolio together with the user's risk appetite;

2) Hybrid Value at Risk (HVaR) Calculation Module, for calculate VaR and Stress VaR according to user specifications on time-horizon, historical scenarios, the principle of calculation of each type of VaR value is the probability ratio multiplied by volatility of each security in a given portfolio, as shown in Equation 1:

V₁=α·σ(x) Equation 1

where
α is an adjustment ratio corresponding to probability, the ratio that this invention utilises during the calculation of risk is 99% and 95%;
σ(x) is the volatility of each security in the portfolio.

In addition to the calculation of VaR value base on specified time horizon, the HVaR Calculation Module also calculates historical VaR V₂ and Monte-Carlo VaR V₃; the scenario of historical VaR calculation is according to any historical scenario that user may specify; after all 3 types of VaR components are obtained, the final HVaR is calculated with the correlation efficients between those VaRs, as shown in Equation 2:

$$V = {\sum }_{i = 1}^{3} {w}_{i} \cdot {V}_{i} \qquad Equation 2$$

Where:
wᵢ is weight ratio for each VaR component;
Vᵢ is value of each VaR component.

As shown in FIG. 1, this hybrid VaR calculation process produces a VaR result that is adaptive to any scenarios and can be adjusted on demand according to the economic environment for any given time in the future and user's risk appetite, thus making the result a better fit for the real world;

3) Portfolio Optimisation Module, for calculation of the optimum weight combination of securities in a given portfolio which minimises risk, achieves portfolio expected return while taking optimisation P&L into account and at the same time satisfies position size limit and long/short position limitations. The return of a given portfolio can be described by Equation 3:

$$E ( {r}_{p} ) = {\sum }_{i = 1}^{n} {w}_{i} \cdot E ( {r}_{i} ) \qquad Equation 3$$

Where:

[symbol] :
E(r) is expected returns of securities and portfolio;
p is the given portfolio;
n is the number of positions in the given portfolio, n≧1;
w is the weight ratio of each security;
position lower limit≦wᵢ≦position upper limit;
position lower limit≦position upper limit;

The P&L generated from trades necessary to optimise the portfolio in real world affects the actual return achieved from portfolio optimisation, making it higher or lower than the strictly theoretical result from math calculation, as shown in FIG. 1, a unique characteristic of this invention is that taking this real-world benefit/cost into consideration by bringing it into the optimisation calculation as a input factor which is dynamically adjusted so that the result is more adequate for real world investment optimisation and management, the adjustment procedure is shown in Equation 4 and Equation 5.

E(r_{target})=E(rₚ)+ω Equation 4

Where:

[symbol] :
E(r_{target}) is the system adjusted portfolio target expected return;
E(rₚ) is the user defined original expected return;

ω is the optimisation P&L adjustment factor;

$$ω = {\sum }_{i = 1}^{n} {w}_{i} \cdot {Δ}_{i} \qquad Equation 5$$

Where;

[symbol] :
w is the weight ratio of each individual security;
Δ is optimisation P&L adjustment factor for each security;
n is the number of positions in the given portfolio, n≧1;

The relationship between portfolio expected return and its corresponding risk is described in Equation 6:

X=E(rₚ)−0.5*V²*A Equation 6

Where:
E(r) is expected return;
V is portfolio risk;
A is the user's risk appetite, higher absolute value of this figure indicates higher risk aversion, A>0;

The Portfolio Optimisation Module calculates the optimum weight combination w according to the aforesaid equations, the optimisation result minimises risk while generates expected return and satisfies any user specified limitations on position size, long/short position and trade direction;

4) Result Analysis Module, for quantitatively analysing VaR and optimisation calculation results, analysing the improvement on pre-optimisation portfolio as a result of this optimiation process, and detailed list of necessary trades that are required to achieve the optimum portfolio from its current pre-optimisation state, together with P&L and cash flow generated from those trades;

5) Result Presentation Module, for presenting the calculation results of HVaR and optimisation calculations. The presented items include but are not limited to optimum weight ratio of each security; expected and system auto-generated return of each security; resulting portfolio return; pre-optimisation security and portfolio VaR; pre-optimisation security and portfolio return; necessary trades for converting pre-optimisation portfolio to optimum; optimisation P&L generated from the aforesaid trades in percentage and value figure; security name, trade direction, price and cash flow of each trade mentioned above.

A method that optimises portfolio with the aforesaid software tool, the characteristics of which include but not limited to the following:

a. The system creates a new portfolio optimisation processing thread and provides user with a User Interface (UI) which is ready to collect user data;

b. When user clicks the “Optimise Portfolio” button, analyse user input and check whether the user has specified expected returns for all securities in the given portfolio, if the answer is yes, enter step d; if not, notify the user of the securities the expected returns of which have not been specified and offer the user the option to let the system automatically estimate the expected returns of those securities; in the case of the user choose to fulfill those missing data and click the “Optimise Portfolio” button again, restart step b and re-analyse user data to determine whether to proceed to step d; if the user choose to let the system estimate expected returns, proceed to step c;

c. Quantitatively estimate the expected returns for all securities the expected return of which have not been specified by the user, then proceed to step d;

d. Analyse user input and check whether the user has specified any position size boundary limit on any security in the concerned portfolio, if so, proceed to step e; if not, enter step f;

e. If user specified position size limits are greater than 0% or less than 100%, and the upper limit is greater than the lower limit, proceed to step f; if that is not the case, return to step b and re-collect user data;

f. Check user data for the risk appetite factor, if it is specified, proceed to step g; if not, return to step b and re-collection user data;

g. Check whether the user chooses to add optimisation P&L as a calculation factor in the mathematical quest for the optimum weight ratios, if the answer is yes, add this factor in the input factor list, proceed to step h; if not, enter step h directly without adding optimisation P&L into the factor list;

h. In this pre-optimisation estimation step, analyse user specified expected return, position size upper/lower limits, VaR time horizon and VaR calculation results, estimate whether the given user input can theoretically produce a logical optimisation result that satisfies the user's expected portfolio return, if so, enter step j; if not, proceed to step i;

i. Automatically adjust the expected portfolio return value base on the given user input so that all input to the optimisation calculation are logically valid, then proceed to step j;

j. Check whether the user allows long/short positions in the optimisation result, if so, store the user preference on this long/short positions and corresponding size limits which is utilized later during the optimisation process, then proceed to step k; if not, set the default preference as allowing both long and short positions, then proceed to step k;

k. Calculate VaR for all user specified securities base on time-horizon, historical scenarios and Monte-Carlo simulation, produce the hybrid VaR in accordance to the correlation factors between each VaR factor. If time-horizon or historical scenario is not specified, the system sets the default time horizon as 1 day and default scenario as the 2007 subprime mortgage crisis initiated global financial meltdown, proceed to step l;

l. Conduct portfolio optimisation calculation base on user data collected from steps b to k and corresponding market data, produce the optimum weight combination for securities in the portfolio, the portfolio expected return and portfolio risk on completion of the optimisation calculation, proceed to step m;

m. Calculate pre-optimisation portfolio P&L and portfolio risk, produce a comparison report on pre and post optimisation portfolio performance store for later UI presentation and search facilities, proceed to step n;

n. If dynamic optimisation P&L is not specified as a calculation input factor, then analyse the differences between positions pre and post optimisation on each security, calculate and produce the trades necessary to bring the current portfolio to the optimum, together with the corresponding P&L generated by those trades, enter step o after storing the results; in the case of user specified expected return for each security and the portfolio fall outside of the optimisation P&L, then reduce the optimisation P&L to 0 and restart step m; If optimisation P&L is added as a calculation factor and the optimisation result satisfies the optimisation P&L boundary, the optimisation is considered a success under this specific condition and result stored for later presentation, proceed to step o;

o. Present calculation and optimisation results at UI.

It is clear and obvious that the methods and tools in this invention not only enable investors to observe performance and risks of their portfolios, but more importantly, provide investors with a way to optimise their portfolio in real-world which minimises risk while generate portfolio expected return and satisfies position limits, limitations on long/short position and trade direction. The unique characteristics of the invention are as follows:

1) On applicability and feasibility, this invention is applicable for portfolios of any combination of multiple types of financial products, the optimisation calculation conditions can be adjusted according to any user preferences on position size limit, long/short position and trade direction, which ensures the calculation result falls within the critical boundaries;
2) On the calculation of hybrid VaR, the hybrid VaR is calculation result of multiple VaR value factors, this method introduces Historical VaR and Monte-Carlo VaR values as adjustment factors, which not only reduces the margin of error when defining calculation boundaries, but also enables user to define VaR boundaries according to specific economic environment;

3) On portfolio optimisation, introduce optimisation P&L as a calculation input factor which is utilised to dynamically adjust calculation boundaries and ensures the optimisation result is the actual optimum and real-world workable;

4) The optimisation process quests for the weight combination that minimises risk for a given expected return as opposed to questing for the maximum return under the same condition;

5) Produce detailed list of necessary trades to convert the pre-optimisation portfolio to optimum portfolio, together with corresponding P&L and cash flow generated from those trades;

6) On suitable clients and business environments, when designing the UI, this invention automatically adjusts position size limit and expected return values in the case of user fails to specify logical figures for those fields, the user is notified of such adjustments via the UI. The reason for this is to take into consideration the difference between investors on their capability of understanding the market multiple products; while in the result analysis process, the system produces the comparison of weight ratio combinations between pre and post optimisation, which facilitates the user for a better understanding of the given portfolio.

7) On data processing, separates complex data collection, data mining, multi-dimensional non-linear calculations and data storage processes from the front end user interface module, which reduces the complexity of the UI of the software tool and helps the user focus on the analysis of the given portfolio.

### DETAILS OF ONE OF THE IMPLEMENTATION METHOD OF THE INVENTION

The following is the description of the actual implementation of this invention, the implementation roadmap of this invention is not limited to the implementation described here. The data flow of the software system is as shown in FIG. 9, the logics model is shown in FIG. 3, FIGS. 10 and 11 describes the user interface of the software tool. This software tool minimises risk while producing expected return and at the same time satisfies position limits, limitations on long/short position and trade direction. The software interacts with the user via internet based website and mobile client app, services are delivered via the internet. Details of the implementation of this software tool are as follows:

1) User Data Collection Module

2) Hybrid VaR Calculation Module

3) Portfolio Optimisation Calculation Module

4) Optimisation Result Analysis Module

5) Result Presentation Module

In the actual implementation, the back-end units of the portfolio optimisation software tool are located on web server, while the front-end interfaces are presented as web pages and mobile app, users interact with this software tool through the front-end interface, and the system presents results of calculations and analysis on the front-end UI as well. In the actual implementation of the software system, all intensive calculations and analysis are processed at the server side of the system, the front-end UI exchanges data with the back-end server through SSL secured connection.

1) User Data Collection Module

The User Data Collection Module is as shown in FIG. 4, this unit collects detailed information about the given portfolio, in addition to user's specification on input factors for portfolio optimisation calculation.

The detailed information collected on the given portfolio includes:
Name of each security;
Type of each security;
Price(s) of each security;
Long/short positions and size of the positions;

The calculation input factors collected include:
Expected return on each security;
Upper and lower limits on any position;
Portfolio expected return;
User's preference on whether system auto-estimation of expected return on any security activated;
User's specification on VaR time horizon;
User' specification on Historical VaR scenario;
User's risk appetite;
User's specification on whether to activate optimisation P&L adjustment;

The data collection process is initiated after the user clicking the “Portfolio Optimisation” button on the data collection page of the UI, the system data collection process are as follows:

1.1) If the expected return of some securities are not specified by the user, the system UI alerts the user and offer the user to choose whether to let the system automatically quantitatively estimate the expected returns of those securities, or the use can choose to fill the missing data; if the user chooses to let the system estimate the missing data, then the system proceeds to the estimation process and presents the user with the estimation result and proceed to step 1.2; in the case that the user chooses enter the missing data, then data collection process of step 1.1 is reinitiated;

1.2) Check and validate whether the user has specified “upper limit %” or “lower limit %” position size limitations on any securities as part of the optimisation condition boundary, if so, proceed to step 1.3; if not, enter step 1.4;

1.3) Check and validate whether the user specified position size upper and lower limits satisfy the following conditions:

0%≦w≦100%; and

wₗ≦wᵤ

Where

w is position size limit;

wₗ is position size lower limit;

wᵤ is position size upper limit.

If the user input meets the criteria, store the data and proceed to step 1.4; otherwise, loop back to the data collection page and reinitiate step 1.1;

1.4) Check and validate that whether portfolio expected return is specified by the user, if so, proceed to step 1.5; if not, back to the data collection page and reinitiate the data collection process step 1.1;

1.5) Check and validate whether the portfolio expected return specified satisfies the following condition:

rₛₗ≦rₚ≦rₛᵤ

Where

rₛ₁ is the lowest expected return of any given security in the portfolio;

rₛᵤ is the highest expected return of any given security in the portfolio;

rₚ is the portfolio expected return.

If the user specified data meets the above criteria, proceed to step 1.6; if not, the system automatically adjust the expected return of the portfolio to the highest value possible logically and notify the user of the adjustment in the front-end UI before proceeding to step 1.6;

1.6) Check and validate whether there are securities that are supports for short positions, if so, proceed to step 1.7 and enter step 1.9 otherwise;

1.7) Check and validate whether short positions are allowed in the optimisation result by the user, if that is the case, proceed to step 1.8, enter step 1.9 otherwise;

1.8) Apply optimisation input factors on the server side and automatically enable “allowing short positions” in the input factors setting, proceed to step 1.10;

1.9) Apply optimisation input factors on the server and disable “allowing short positions” in the input factors settings, proceed to step 1.10; 1.10) Check and determine whether a valid time horizon has been specified for VaR calculation, proceed to step 1.11 if that is the case; otherwise, the system automatically sets the time horizon to 1 day and proceed to step 1.11;

1.11) Check and validate a valid scenario is specified for historical VaR calculation, if so store the specification and proceed to step 1.12; if not, the system automatically sets the 2007 world financial crisis as the default historical scenario and proceed to step 1.12;

1.12) Check and validate that user has specified risk appetite ratio, if so proceed to step 1.13; otherwise, a notification dialogue is populated which collects user risk appetite, check and validate user input, start procedure 1.12 if the specified value is negative or 0, proceed to step 1.13 otherwise;

1.13) Check and validate that whether optimisation P&L input factor is enabled by the user, store user preference on this and proceed to the Hybrid VaR Calculation Module.

### 2) Hybrid VaR Calculation Module

The Hybrid VaR Calculation Module calculates portfolio HVaR base on user preference, and stores the calculation result for the optimisation calculation at later stage, as shown in FIG. 5, the detailed procedures are:

2.1) Identify product types of all securities specified by the user and proceed to step 2.2;

2.2) Determine VaR time horizon base on user specification and proceed to step 2.3;

2.3) Calculate current weight combination of all securities in the portfolio base on position size and price MTM;

2.4) Calculate VaR (99%) base on user specified time horizon and proceed to step 2.5;

2.5) Calculate Stress VaR base on user specified historical scenario and proceed to step 2.6;

2.6) Calculate portfolio Monte-Carlo Stress VaR and proceed to 2.7;

2.7) Calculate HVaR base on the values and correlation between VaR, Historical Stress VaR and Monte-Carlo Stress VaR, store the calculation result for the optimisation calculation at later stage.

### 3) Portfolio Optimisation Calculation Module

The Portfolio Optimisation Calculation Module calculates the optimum weight combination that minimises risk, produces the user specified expected return and at the same time satisfies the position size limits, limitations on long/short positions and trade directions specified by the user, in the case of the option of “optimisation P&L dynamic adjustment” is enabled by the user, the optimisation calculation compensates optimisation P&L dynamically for a real-world optimum portfolio with optimisation trades taken into account, as shown in FIG. 6, the detailed steps are as follows:

3.1) Define optimisation calculation boundary conditions according to user preference as follows, then proceed to step 3.2:
Expected return in calculation result is set to the target return specified by the user, with margin of error set to be less than 1%;
The sum of total weight combination for all securities is 100%;
Position weight upper limit boundary≦user specified weight upper limit;
Position weight lower limit boundary≧user specified weight lower limit;
If short position is disallowed in the result of the calculation by the user, the lower weight limit for all positions are set to ≧0;
Specify user risk appetite;
Configure the dynamic optimisation P&L adjustment option according to user preference, if this option is disabled, this value is permanently set to 0.

3.2) Combine boundary condition defined in step 2 and 3.1 to form the optimisation boundary condition, then solve the non-linear multi-dimension problem mathematically and quantitatively quest for the optimum weight combination of securities that falls within the boundary definition, which is the weight combination that minimises risk, proceed to step 3.3;

3.3) In the case that the dynamic optimisation P&L adjustment option is enabled, proceed to step 3.4; otherwise enter step 3.5;

3.4) If the optimisation P&L adjustment falls within the region defined by the calculation result, proceed to step 3.6; any other case indicates that the user defined conditions on expected return and position size limits logically do not allow dynamic optimisation P&L adjustment, the dynamic optimisation P&L adjustment factor is set to 0, and the calculation process loops back to step 3.3;

3.5) Calculates the weight differences between pre and post optimisation portfolio, proceed to step 3.6;

3.6) Store the following calculation result and input factors and proceed to the Calculation Result Analysis Unit:
Weight combination prior to optimisation calculation;
Weight combination after optimisation calculation;
Difference between security weights pre and post calculation;
Portfolio VaR after optimisation;
Portfolio P&L after optimisation;
Margin of error of the calculation result;
Sensitivity of the calculation result to user input factors;

Calculation user input factors include:
Expected returns;
Upper and lower limit on position size;
Long and short limitations on security positions;
VaR time horizon and historical scenario;

### 4) Optimisation Result Analysis Module

As shown in FIG. 7, the detailed steps are:

4.1) The Optimisation Result Analysis Module collects the optimum weight combination, resulting expected return and corresponding VaR and P&L of the post-optimisation portfolio, then proceeds to step 4.2;

4.2) Calculate the VaR and P&L of the pre-optimisation portfolio base on the weight combination, position size specified by the user and the price MTM plus historical data, proceed to step 4.3;

4.3) In the case of dynamic optimisation P&L adjustment is enabled by the user and the optimisation result falls within the boundary conditions, enter step 4.5; otherwise, proceed to step 4.4;

4.4) Calculate the difference between pre and post optimisation weight and P&L for each security in the portfolio and enter step 4.5;

4.5) Calculate the following with weight difference, P&L difference, price MTM and portfolio present value:
4.5.1) Cash flow generated from trades to reflect the weight difference at price MTM, then enter step 4.5.2;
4.5.2) Size of trades corresponding to the trades aforesaid base on the cash flow generated in step 4.5.1, proceed to step 4.6;

4.6) Store results from the calculation for presentation and historical search at later stages and proceed to the Presentation Unit.

### 5) Result Presentation Unit

The result of the optimisation calculation is sent to the client side presentation layer in the form of web pages and mobile app, as shown in FIG. 8, the data transferred are as follows in no particular order:

5.1) Present weight ratio, position size and expected returns of all securities in the user specified portfolio;

5.2) Present the expected return and associated VaR of the optimised portfolio;

5.3) Present the optimisation P&L and cash flow generated from optimisation-required trades in percentage and value figure, i.e. the results from step 4.4.1;

5.4) Present details of the trades necessary to convert the current portfolio to the optimum portfolio, i.e. the results from step 4.4.2, the details of which are as follows:
Buy or sell;
Name and ISIN of the security;
Size of trade;
Prices;
Cash flow.

5.5) Present all input factors of the optimisation calculation.

For practitioners in the field of this invention, the ways of implementation of the invention are not limited in any way of form to the details disclosed in this implementation, the implementation of this invention may take other way or form according to its core principles and characteristics. Therefore, the implementation described herein should be considered as explanatory, and should not limit the scope of the protection applicable to this invention in any circumstances, the scope of this invention is defined in the demands of this invention, therefore, any variation that falls within the scope and principle of the demands of this invention should be protected as part of this invention.

### BRIEF DESCRIPTION OF THE SEVERAL VIEWS OF THE DRAWINGS

FIG. 1 Efficient Frontier incorporated effective boundary

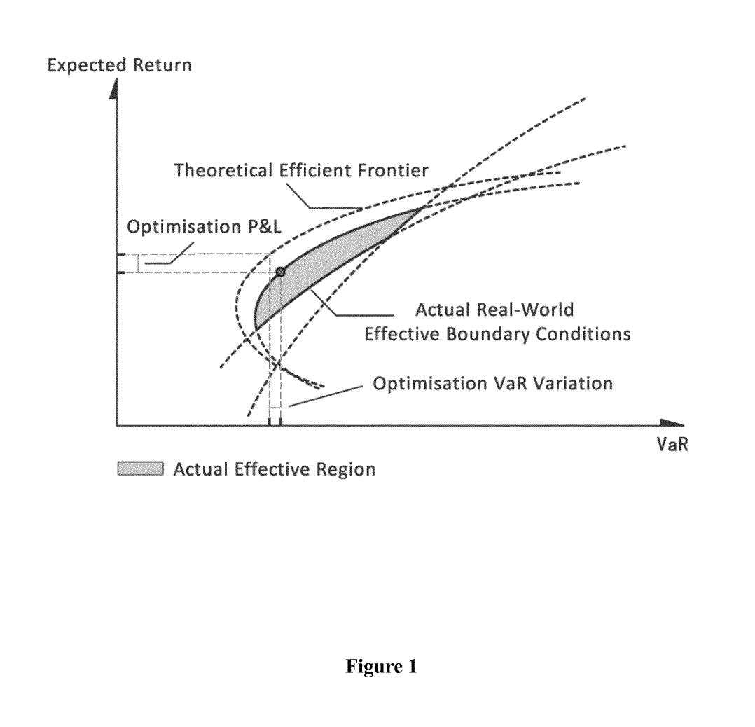

FIG. 2 Relationships between functional modules of the software tool in this invention

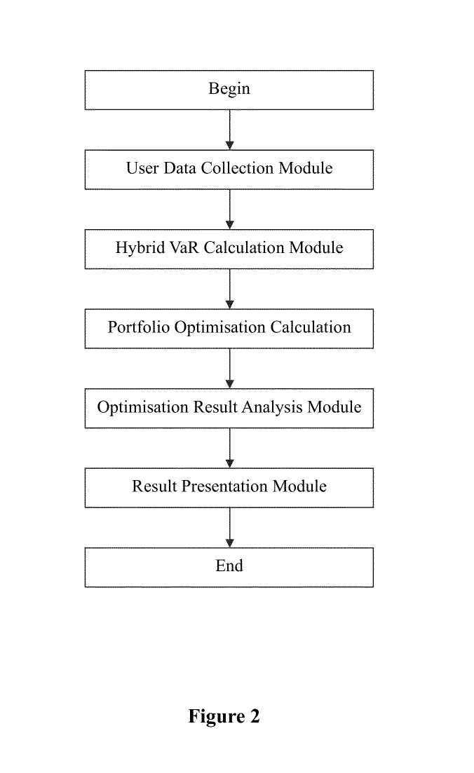

FIG. 3 Logical model of this invention

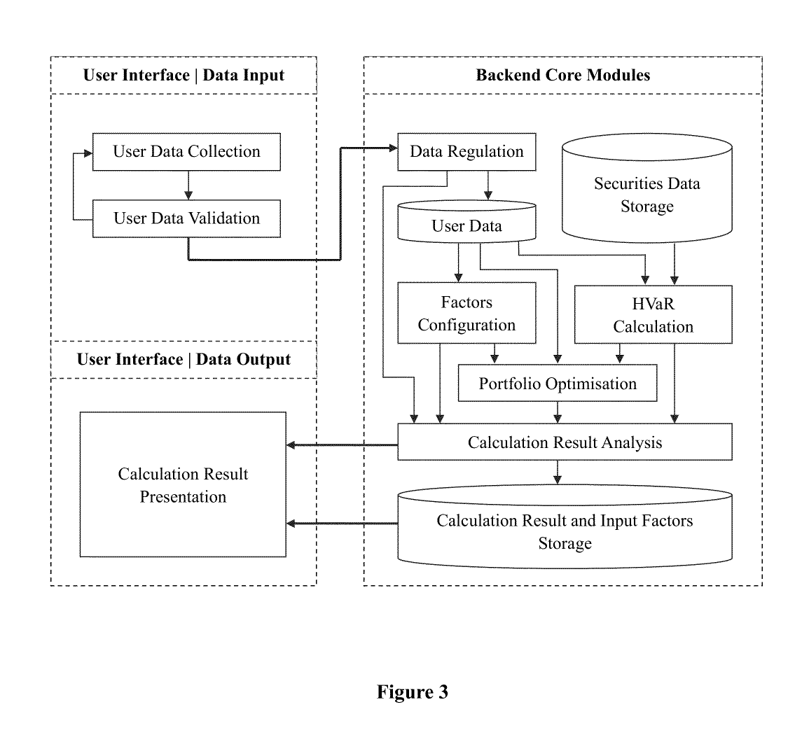

FIG. 4 Operation flow of the User Data Collection Unit of the software tool in this invention

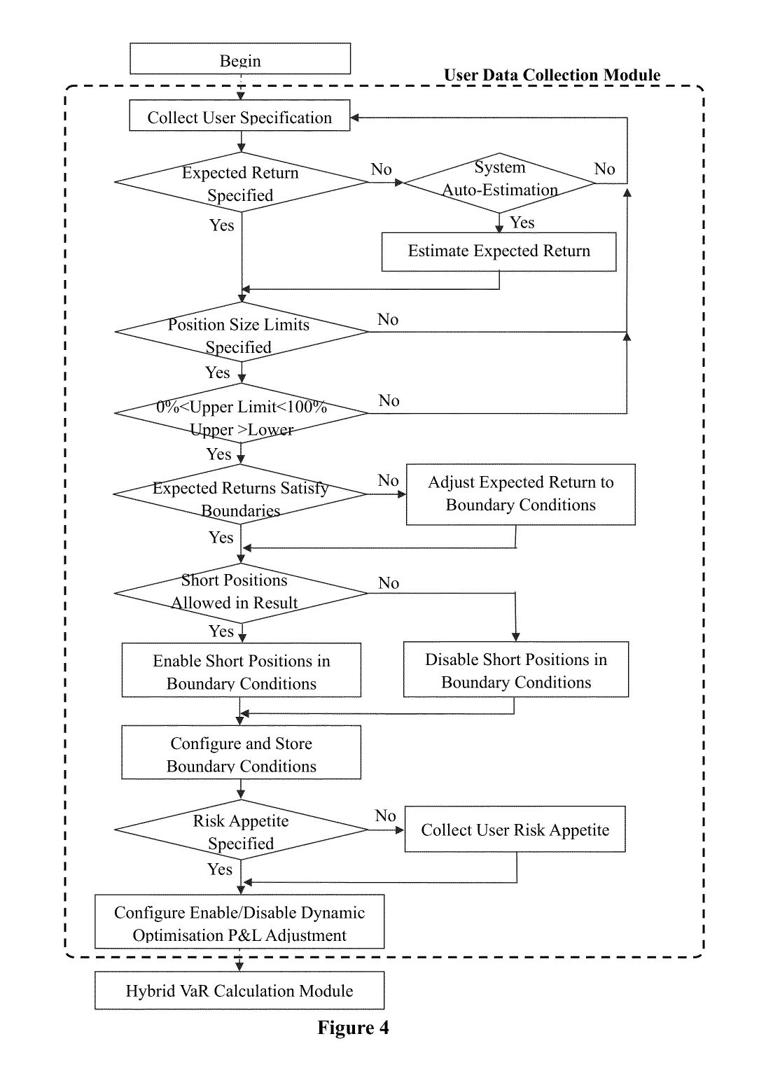

FIG. 5 Operation flow of the Hybrid VaR Calculation Unit of the software tool in this invention

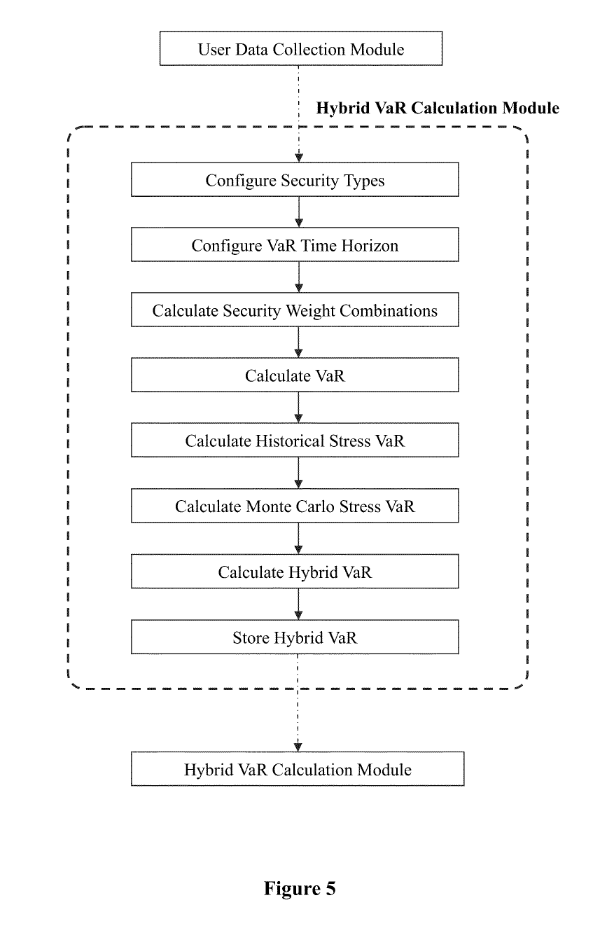

FIG. 6 Operation flow of the Portfolio Optimisation Calculation Unit of the software tool in this invention

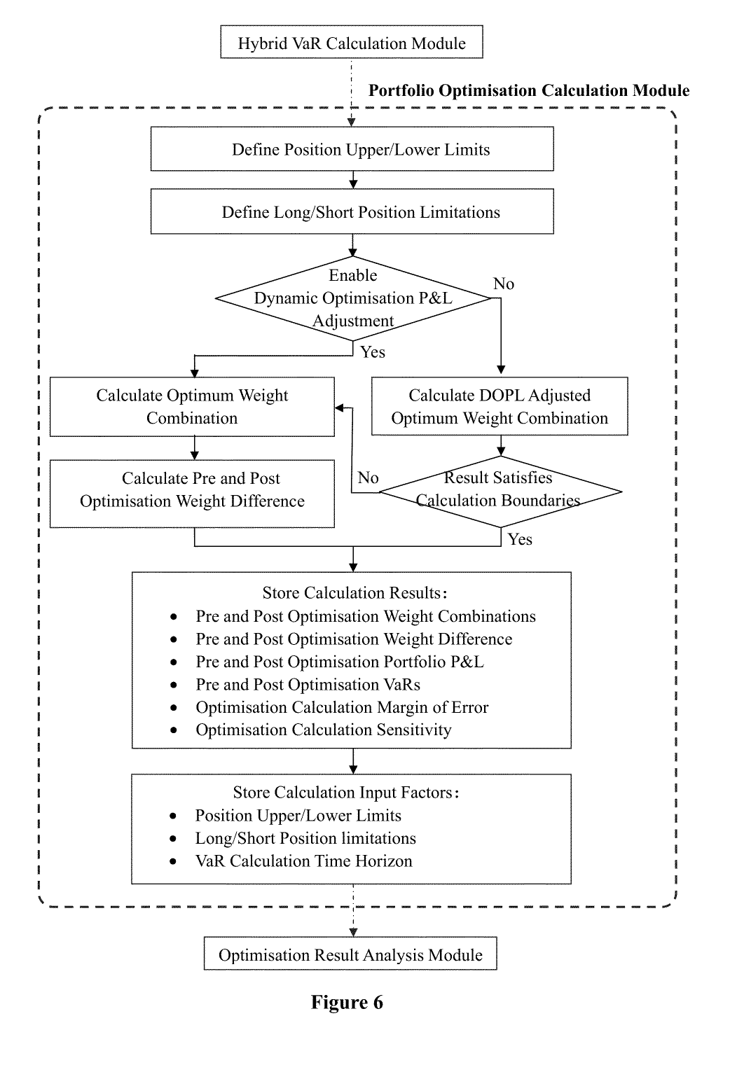

FIG. 7 Operation flow of the Optimisation Result Analysis Unit of the software tool in this invention

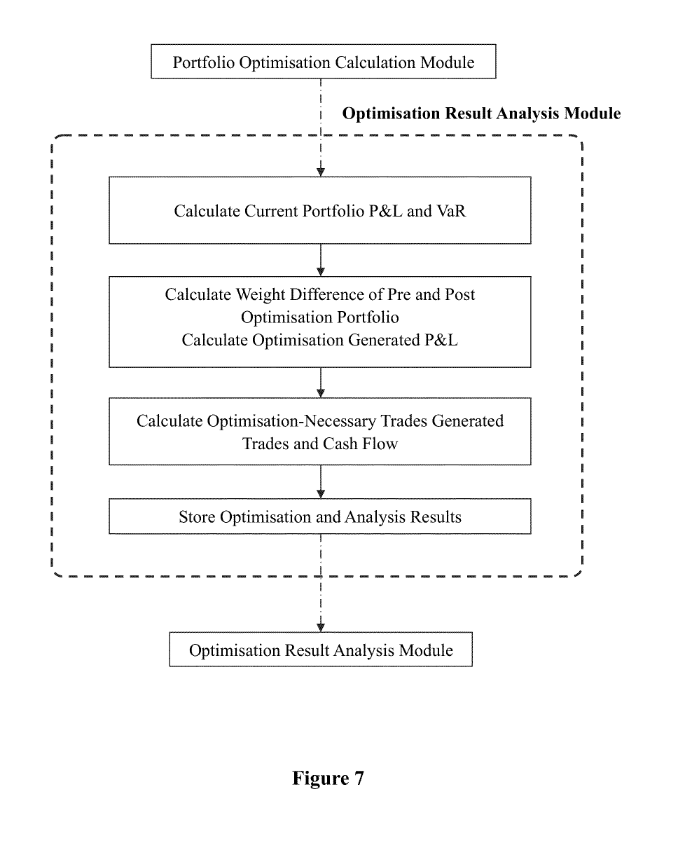

FIG. 8 Operation flow of the Result Presentation Unit of the software tool in this invention

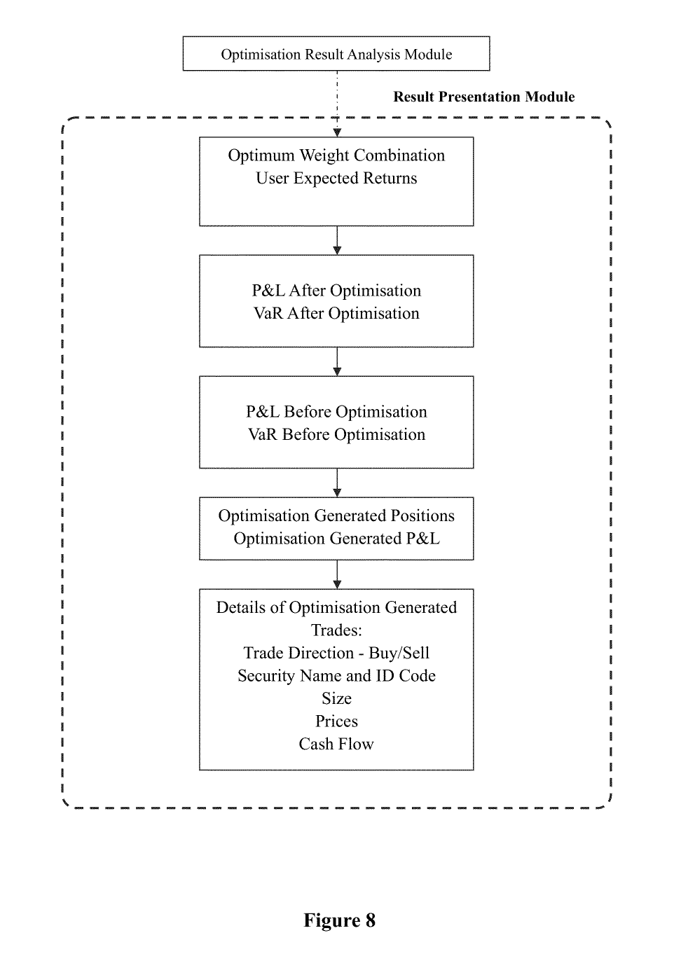

FIG. 9 Data flow between functional modules of the software tool in the invention

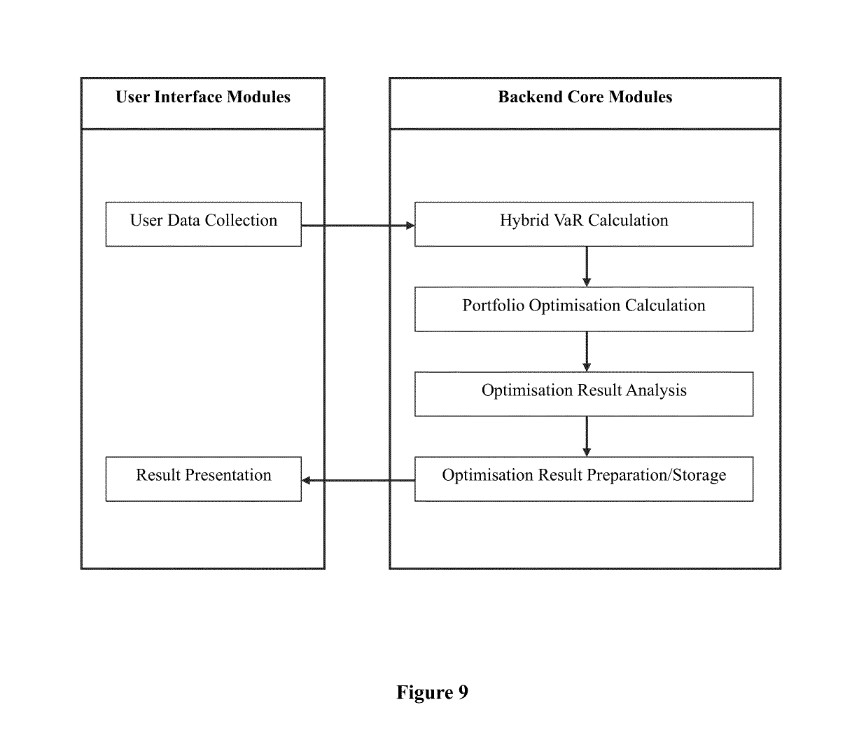

FIG. 10 Screenshot of actual implementation of the software tool in this invention—User Data Collection

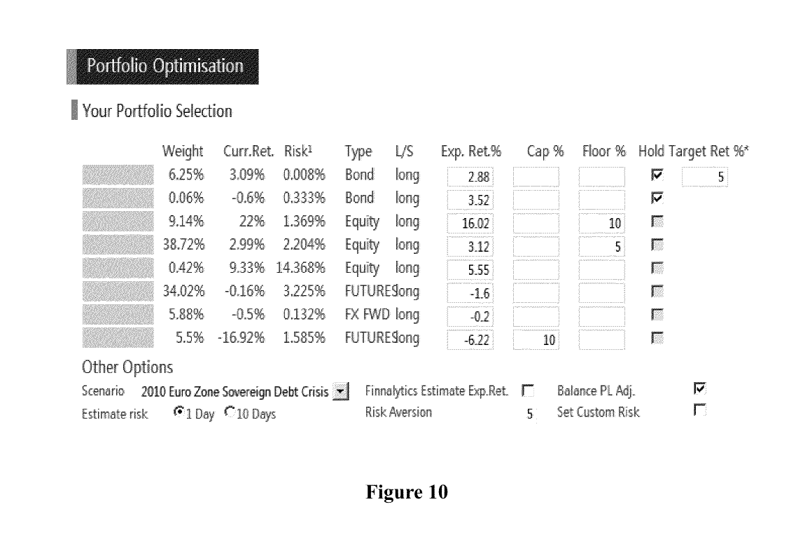

FIG. 11 Screenshot of actual implementation of the software tool in this invention—Optimisation Calculation Results Presentation

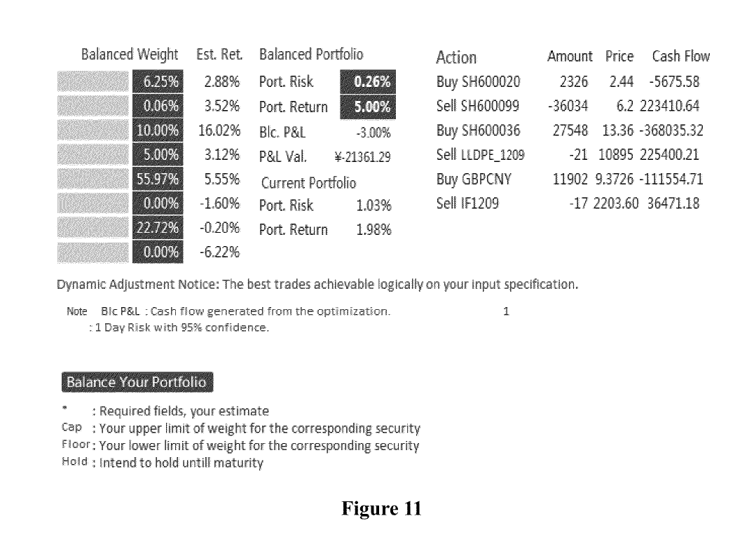

1. A portfolio optimization method that minimizes risk while satisfying the expected return of any given investment portfolio, its unique characteristics include:
For a given investment portfolio, calculate its value at risk (VaR) and the correlation between VaR and Stress VaR base on positions in the portfolio, at the same time collect user's expected return on the portfolio and custom limitations on any given positions;
Dynamically adjust the boundaries of the multi-dimensional non-linear optimisation calculation base on interim optimisation VaR and optimisation Profit and Loss (P&L);
Mathematically obtain the optimum weight ratio combination that produces the minimum risk, satisfies the expected return of the portfolio and stays within the efficient frontier of the defined problem;
Calculate the required trades to achieve the mathematically obtained optimum portfolio, together with the profit and loss (P&L), and cash flow corresponding to those trades.

2. The method of claim 1, wherein the user data collection mechanism collects user's expected return on securities, user specified upper and lower limitations on the position of each security in a portfolio, user expected return on the given portfolio, user specified time horizon on the calculation result, user specified limitation on after-optimisation long/short positions, user's preference on whether to employ dynamic P&L adjustment during calculation, automatically quantitatively calculate expected return of securities in the user's investment portfolio should the user be unable to provide such estimates.

3. The method of claim 1, wherein a hybrid VaR value is calculated via calculating VaR for user defined time horizon, user defined historical scenarios, and Monte-Carlo Stress VaR, quantitatively calculate a hybrid VaR base on the aforesaid calculation results and at the same time produce the mathematical boundaries for portfolio optimization calculations on the given portfolio.

4. The method of claim 1, wherein the portfolio optimisation calculation mechanism automatically reduces the expected return boundary value for the calculation result to maintain its logicality and relevance when the maximum expected return of securities specified by the user is lower than user defined expected return on the concerned portfolio.

5. The method of claim 1, wherein the portfolio optimization calculation mechanism automatically produces a weight combination that meets user defined boundaries and generates the highest return amongst all possible solutions when user defined position size limits on securities in a given portfolio theoretically prevent the successful achievement of user defined expected return mathematically.

6. The method of claim 1, wherein the calculation automatically produces an optimum weight combination that satisfies the user's specification when user explicitly specifies certain long or short positions to be included in the optimization result.

7. The method of claim 1, wherein at least one algorithm that solves multi-dimensional non-linear equations is employed to produce the optimum weight combination for the portfolio.

8. The method of claim 1, wherein the multi-dimensional calculation boundaries are defined by at least but not limited to the expected returns of each security, position size limits, limitation on long/short position, limitation on trade direction, risk boundaries, VaR calculation time-horizon, and the user's expected portfolio return.

9. The method of claim 1, wherein the value and percentage of optimization P&L, which adjusts optimisation result to compensate the effect of profit and loss generated by the necessary trades for converting the pre-optimisation portfolio to the resulting real-world optimum, can be added as a participating input factor during the portfolio optimization calculation. User has the option to include or not include the aforesaid dynamic optimisation P&L adjustment factor during the optimisation calculation.

10. The method of claim 1, wherein the reporting mechanism not only produces the optimum weight combination for securities in a given portfolio, but also the total risk of the portfolio and the P&L as a result of the concerned optimisation process, optimisation required trades and associated P&L and cash flow for each security are listed in percentage and actual value accordingly.

11. A software tool that is based on the aforesaid portfolio optimization method, the characteristics of which include at least the following:
a. The system creates a new portfolio optimisation processing thread and provides user with a User Interface (UI) which is capable of and ready to collect user data;
b. When user clicks the “Optimise Portfolio” button, analyse user input and check whether the user has specified expected returns for all securities in the given portfolio, if the answer is yes, enter step d; if not, notify the user of the securities the expected returns of which have not been specified and offer the user the option to let the system automatically estimate the expected returns of those securities; in the case of the user choose to fulfill those missing data and click the “Optimise Portfolio” button again, restart step b and re-analyse user data to determine whether to proceed to step d; if the user choose to let the system estimate expected returns, proceed to step c;
c. Quantitatively estimate the expected returns for all securities the expected return of which have not been specified by the user, then proceed to step d;
d. Analyse user input and check whether the user has specified any position size boundary limit on any security in the concerned portfolio, if so, proceed to step e; if not, enter step f;
e. If user specified position size limits are greater than 0% or less than 100%, and the upper limit is greater than the lower limit, proceed to step f; if that is not the case, return to step b and re-collect user data;
f. Check user data for the risk appetite factor, if it is specified, proceed to step g; if not, return to step b and re-collection user data;
g. Check whether the user chooses to add optimisation P&L as a calculation factor in the mathematical quest for the optimum weight ratios, if the answer is yes, add this factor in the input factor list, proceed to step h; if not, enter step h directly without adding optimisation P&L into the factor list;
h. In this pre-optimisation estimation step, analyse user specified expected return, position size upper/lower limits, VaR time horizon and VaR calculation results, estimate whether the given user input can theoretically produce a logical optimisation result that satisfies the user's expected portfolio return, if so, enter step j; if not, proceed to step i;
i. Automatically adjust the expected portfolio return value base on the given user input so that all input to the optimisation calculation are logically valid, then proceed to step j;
j. Check whether the user allows long/short positions in the optimisation result, if so, store the user preference on this long/short positions and corresponding size limits which is utilized later during the optimisation process, then proceed to step k; if not, set the default preference as allowing both long and short positions, then proceed to step k;
k. Calculate VaR for all user specified securities base on time-horizon, historical scenarios and Monte-Carlo simulation, produce the hybrid VaR in accordance to the correlation factors between each VaR factor. If time-horizon or historical scenario is not specified, the system sets the default time horizon as 1 day and default scenario as the 2007 subprime mortgage crisis initiated global financial meltdown, proceed to step 1;
l. Conduct portfolio optimisation calculation base on user data collected from steps b to k and corresponding market data, produce the optimum weight combination for securities in the portfolio, the portfolio expected return and portfolio risk on completion of the optimisation calculation, proceed to step m;
m. Calculate pre-optimisation portfolio P&L and portfolio risk, produce a comparison report on pre and post optimisation portfolio performance store for later UI presentation and search facilities, proceed to step n;
n. If dynamic optimisation P&L is not specified as a calculation input factor, then analyse the differences between positions pre and post optimisation on each security, calculate and produce the trades necessary to bring the current portfolio to the optimum, together with the corresponding P&L generated by those trades, enter step o after storing the results; in the case of user specified expected return for each security and the portfolio fall outside of the optimisation P&L, then reduce the optimisation P&L to 0 and restart step m; If optimisation P&L is added as a calculation factor and the optimisation result satisfies the optimisation P&L boundary, the optimisation is considered a success under this specific condition and result stored for later presentation, proceed to step o;
o. Present calculation and optimisation results at UI.

12. The software tool of claim 1l, wherein step j, determine whether and how long/short position and size limits are set base on the type of user specified securities, check whether the security is futures product, if so, set default long/short position and size limit to “allow”, −100% to 100%, store this setting for later calculations; if not, the default is set to long only, which can be specified by to the user to include short positions should the user choose to do so.

13. The software tool of claim 1l, wherein step a, the user interface must include at least but not limited to the name, ID code, weight, risk (real-time calculation by the system), type, long/short position, expected return, position size upper/lower limits, portfolio expected return.

14. The software tool of claim 1l, wherein step o, the user interface must present at least but not limited to complete optimum weight combination of securities as the result of portfolio optimisation, expected return of each security in the given portfolio, portfolio risk after the optimisation calculation, portfolio P&L after the optimisation calculation, pre-optimisation portfolio risk, pre-optimisation portfolio P&L, optimisation cost P&L in value and percentage, details of optimisation generated trades including security name, trade type (buy/sell), size, price and trade generated cash flow.
